(19) United States
(12) Patent Application Publication
(10) Pub. No.: US 2005/0048890 A1
(43) Pub. Date: Mar. 3, 2005

(54) Constructive arrangement applied to degreasing gizzard

(76) Inventor: Carlos Antonio Miozzo, Chapeco (BR)

Correspondence Address: Jon P. Christensen;Welsh & Katz, Ltd., 22nd Floor, 120 South Riverside Plaza, Chicago, IL, 60606, US

(21) Appl. No.: 10/854,893

(22) Filed: May 27, 2004

(30) Foreign Application Priority Data
Aug. 15, 2003 (BR) 8.301.641-4

(51) Int. Cl. A22C 21/06

(52) U.S. Cl. 452/114

(57) ABSTRACT

CONSTRUCTIVE ARRANGEMENT APPLIED TO DEGREASER OF GIZZARD, cleaning and conveying the gizzard through water jets and a system of rubber fingers that spin continuously, where the rubber fingers get in touch with the gizzard and makes it spin in the system, with this, the gizzard enters in contact with the water and rubber fingers, being duly clean, and all the grease removed.

### INTRODUCTION

This descriptive report of utility model regards to the constructive arrangement applied to the degreasing of gizzard, with the cleaning and transportation of the gizzard through water jets and a hitting system with rubber fingers that spin in continuous process, where the rubber fingers get in touch with the gizzard and makes them spin within the system. Thus, the gizzard gets in touch with the water and with the rubber fingers, being duly clean, with the removal of almost all the grease in this stage of the process, and the complementation being executed in the following stage.

### STATE OF THE TECHNIQUE

The cleaning of gizzards is always made by some sort of device with rotating drum. It was possible to identify the following document with the searches made.

PI 9,502,800, with date of deposit on Jun. 14, 1995, under the title IMPROVEMENT INTRODUCED IN AUTOMATIC PROCESSOR OF POULTRY GIZZARD. It comprised the device to execute the continuous sequence of the processes of separation of guts, cutting of the pre-ventricle, cutting and positioning of the gizzard, washing and removal of the mucous membrane, with capacity to process 6,500 gizzards per hour, with only one operator, and the cutting of the gizzard being performed by a rotating knife or a cutting disk (27), with the gizzards attached to a chain (19) at an upper part, so that they are cut from below, and this cutting is regulated in distance (proximity/distancing), which allows its use with different sizes of birds and gizzards.

In this process, the gizzard is collected on the helicoidal gear by the production chain, transported on the cutting disk, passing through the opener, by the washing shower, and then pressed in the cylinders. This results in delay and low quality in the opening and cleaning.

### ABSTRACT OF THE MODEL

With the constructive arrangement proposed, the gizzard earns quality in appearance and does not lose weight due to the manner which the opening was previously made, through dragging by a chain that would tore the product, and waste some of it.

The degreaser makes that the gizzard is open, clean, and all its grease removed. It also “massages” the gizzard, in order that the cuticle (yellowish skin) is more easily removed in subsequent process.

Thus, the gizzard needs only to enter aligned within the helicoidal gears. After that, the gizzard goes to the end of the process randomly, allowing an increase to the productive capacity.

The conveyance chain of the gizzards is eliminated, avoiding the cutting of the gizzard and increasing the quality of the product and the productivity of the equipment, additionally to the reduction of costs with maintenance and operation.

### BENEFITS OF THE MODEL

The improvement proposed brings a series of benefits to the user, such as:
increase in the final productive capacity of the machine;
increase in the cleaning patterns;
reduction in costs with maintenance;
low operational cost;
high final quality of the gizzard;
best cleaning and opening;
more removal of grease; and
cleaning and degreasing of the gizzard without damages.

### DESCRIPTION OF THE FIGURES

The characterization of this document of utility model proposed herein is made through representative drawings of the constructive arrangement of the gizzard degreaser, in order that the machine or equipment is fully reproduced by the appropriate technique, allowing full characterization of the functionality of the object pleaded.

Based on the figures elaborated, which express the best, or preferential, form of how to construct the product proposed herein, is the basis of the descriptive part of the report, through a detailed and consecutive numbering that establishes aspects that may be identified by the representation adopted, in order to clearly determine the protection claimed herein.

These figures are merely illustrative, with possibility of variations, provided that not deviating from the original proposal.

FIG. 1 illustrates a representation in perspective of the cleaning set proposed;

FIG. 2 illustrates the representation in longitudinal cut of the hitter from front view;

FIG. 3 illustrates the representation of the hitter in longitudinal cut from upper view; and

FIG. 4 illustrates another view of the hitter, in cross-section.

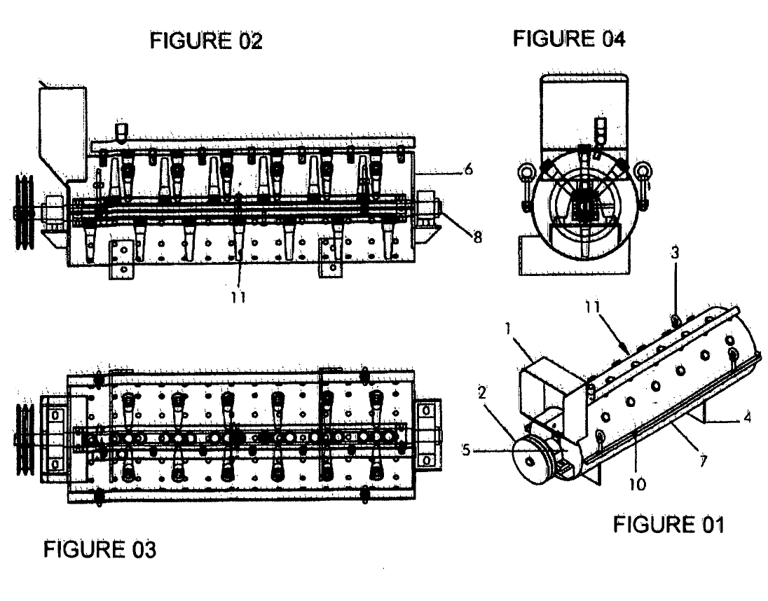

### DETAILED DESCRIPTION OF THE MODEL

The hitter proposed comprised a fixed drum 9, provided with an articulated upper cover 1 allowing access to the lower end 9, containing the body 7 or the lower part of the drum, said body 7 containing fixation supports in the carcass of a machine processor or gizzard, and profiles 10 welded to the body, considering that these profiles 10 project pins 3 where it is possible to lift the hitter, further counting on a pulley 2 linked to a chain engine, which spins the central axle of the hitter 8 from where the rubber fingers 1 stand out, and two lateral covers 5 and 6.

1. CONSTRUCTIVE ARRANGEMENT APPLIED TO DEGREASER OF GIZZARD, characterized by the fact that the degreaser cleans and removes all the grease after the opening of the gizzard, also “massaging” the gizzard in order that the cuticle (yellowish skin) is more easily removed in subsequent process.

2. CONSTRUCTIVE ARRANGEMENT APPLIED TO DEGREASER OF GIZZARD, as of the claim above, where the equipment proposed is preferentially constructed and characterized by the fact of comprising a fixed drum 9, provided with an articulated upper cover 1 allowing access to the lower end 9, containing the body 7 or the lower part of the drum, said body 7 containing fixation supports in the carcass of a machine processor of gizzard, and profiles 10 welded to the body, considering that these profiles 10 project pins 3 where it is possible to lift the hitter, further counting on a pulley 2 linked to a chain engine, which spins the central axle of the hitter 8 from where the rubber fingers 1 stand out, and two lateral covers 5 and 6.
